(19) United States
(12) Patent Application Publication
(10) Pub. No.: US 2015/0127151 A1
(43) Pub. Date: May 7, 2015

(54) Method For Programming Movement Sequences Of A Redundant Industrial Robot And Industrial Robot

(71) Applicant: KUKA Laboratories GmbH, Augsburg (DE)

(72) Inventors: Martin Riedel, Augsburg (DE); Rainer Bischoff, Augsburg (DE)

(21) Appl. No.: 14/523,533

(22) Filed: Oct. 24, 2014

(30) Foreign Application Priority Data
Nov. 5, 2013 (DE) 10 2013 222 456.7

(51) Int. Cl. B25J 9/00; B25J 9/06

(52) U.S. Cl. CPC B25J 9/0081; B25J 9/06; Y10S 901/04
USPC 700/250; 901/4

(57) ABSTRACT

A method for programming sequences of motion of a redundant industrial robot by manually guided adjustment of the pose of a manipulator arm having a plurality of successive links connected by adjustable joints actuated by at least one robot control unit and including at least one redundant joint. The method includes adjusting in a manually-guided manner the link of the manipulator arm that is associated with a tool reference point from a first position and orientation to a second position and/or second orientation, recalculating joint position values of all of the joints of the manipulator arm from the second position and orientation of the tool reference point while simultaneously resolving the redundancy by determining an optimized joint position value of at least one redundant joint, and automatically setting all of the joints on the basis of the recalculated, optimized joint position values.

The invention relates to a method for programming sequences of motion of a redundant industrial robot by means of a manually guided adjustment of the pose of a manipulator arm of the industrial robot, said manipulator arm comprising a plurality of successive links, which are connected by means of adjustable joints, which comprise at least one redundant joint and which can be adjusted in such a way that they are actuated by at least one robot control unit of the industrial robot. In addition, the invention relates to an associated industrial robot.

The German patent DE 10 2011 106 321 A1 discloses a method, which is intended for controlling a robot, in particular, a human-collaborating robot, and with which a robot-specific or task-specific redundancy of the robot is resolved. In this context a robot is called, in particular, a human-collaborating robot, if this robot physically interacts with a human being. For example, the robot provides for a human being to be in a workspace of the robot. In particular, for such robot applications it is desirable to reduce the consequences of a collision of a contact point of the robot with its surroundings, in particular, the human being. To date, limit values have been specified, for example, in compliance with ISO-10218 for this purpose. These limit values include, for example, a maximum speed of a tool reference point, the so-called tool center point (TCP), of 0.2 to 0.25 m/s. Such human-collaborating robots are available on the market and are also referred to, inter alia, as lightweight robots.

The object of the present invention is to improve, in particular, to simplify the programming of the sequences of motion of a redundant industrial robot by means of a manually guided adjustment of the pose of a manipulator arm of the industrial robot.

This engineering object is achieved by means of a method for programming sequences of motion of a redundant industrial robot by means of a manually guided adjustment of the pose of a manipulator arm of the industrial robot, said manipulator arm comprising a plurality of successive links, which are connected by means of adjustable joints, which comprise at least one redundant joint and which can be adjusted in such a way that they are actuated by at least one robot control unit of the industrial robot, wherein said method comprises the steps:

adjusting in a hand-guided manner that link of the manipulator arm that is associated with a tool reference point from a first position and first orientation in space into a second position and/or second orientation in space,

recalculating the joint position values of all of the joints of the manipulator arm from the second position and second orientation of the tool reference point of the manipulator arm while simultaneously resolving the redundancy by determining an optimized joint position value of the at least one redundant joint,

automatically setting all of the joints of the manipulator arm, actuated by means of the robot control unit, on the basis of the recalculated, optimized joint position values during the manually guided adjustment.

The term “redundant industrial robot” is defined as a manipulator arm, which can be moved by means of a robot control unit and which exhibits more manipulatory degrees of freedom than are necessary to fulfill a task. The degree of redundancy is the product of the difference between the number of degrees of freedom of the manipulator arm and the dimension of the event space, in which the task is to be solved. In this respect it may be a kinematic redundancy or a task-specific redundancy. In the case of the kinematic redundancy, the number of kinematic degrees of freedom, in general, the number of joints of the manipulator arm, is greater than the event space, which is formed by means of the three translational and the three rotational degrees of freedom, i.e., by six degrees of freedom, during movement in space in a real environment. Therefore, a redundant industrial robot can be, for example, a lightweight robot comprising seven joints, in particular, seven rotary joints. In the case of the task-specific redundancy, however, the dimension of the task is smaller than the number of kinematic degrees of freedom of the manipulator arm.

Manipulator arms with the associated robot control units, in particular, industrial robots, are working machines, which can be provided with tools for automatically handling and/or processing objects and can be programmed in a plurality of axes of motion, for example, in relation to orientation, position and work flow. Industrial robots typically have a manipulator arm comprising a plurality of links, which are connected by means of joints, and programmable robot control units (control mechanisms), which automatically control or more specifically regulate the sequences of motion of the manipulator arm while the system is running. The links are moved by means of drives, in particular, electric drives, which are actuated by the robot control unit, in particular in relation to the axes of motion of the industrial robot, where said axes of motion represent the degrees of freedom of motion of the joints.

A manipulator arm, which comprises a plurality of links that are connected by means of joints, can be configured as an articulated robot comprising a plurality of links and joints that are arranged in series one after the other. In particular, the redundant industrial robot can have a manipulator arm comprising seven or more joints.

However, the manipulator arms with associated robot control units, such as industrial robots, may be, in particular, so-called lightweight robots, which can be distinguished from conventional industrial robots primarily due to the fact that they exhibit a size that is optimal for man-machine cooperation and at the same time have a relatively high load-carrying capacity in relation to their intrinsic weight. In addition, lightweight robots can be operated, in particular, in a forced controlled manner, instead of, in a position controlled manner, which simplifies, for example, a manual adjustment of the pose of the manipulator arm. In addition, such a design also makes it possible to achieve a safe man-machine cooperation, because, for example, unintentional collisions of the manipulator arm with human beings can be either prevented or at least minimized in such a way that the human beings do not suffer any injury. Such a manipulator arm or more specifically such a lightweight robot usually has more than six degrees of freedom, so that the net result is an overdefined system, which allows the same point in space to be achieved in the same orientation in numerous poses, in particular, even infinitely many different poses, of the manipulator arm. The lightweight robot can react to external applications of force in appropriate ways. In order to measure the force, it is possible to use force sensors, which can measure the force and torque levels in all three spatial directions. As an alternative or in addition, the external forces can also be estimated without sensors, for example, by means of the measured motor currents of the drives at the joints of the lightweight robot. It is possible to use, as the closed loop control concepts, for example, an indirect force control process by modeling the lightweight robot as the mechanical resistance (impedance) or a direct force control process.

The term “pose of the manipulator arm” is defined very loosely as the sum of all joint positions of the joints of the manipulator arm, where said joints connect the individual links of the manipulator in such a way that said individual links can be adjusted. In the narrow sense the term “pose” in a clearly defined system may also be construed as simply the position and orientation of a reference point, such as, for example, a tool reference point (tool center point/TCP) of the manipulator arm. The tool reference point can be formed, for example, by means of a suitable point on a manual flange of the manipulator arm, on which a gripper, a tool or any other device is mounted, in order to be able to move this by adjusting the pose of the manipulator arm in space. As a general principle, the tool reference point may also be a virtual spatial point outside the manipulator arm, which, however, is connected in a geometrically rigid manner to one of the links of the manipulator arm, in particular, the manual flange of the manipulator arm.

The concept “manually guided adjustment of the pose of the manipulator arm” is generally understood to mean that the instantaneous joint positions of the manipulator arm are changed by the fact that an operator of the industrial robot touches the manipulator arm at one or more of its joints and changes, i.e. adjusts, the pose of the manipulator arm by, for example, pushing, pulling and/or rotating the grasped link(s). In one embodiment, which is presented as an example of the underlying principle, it is possible to mount, for example, a handle or to provide, in particular, to rigidly mount, at least a section of a handle, on the last link of the manipulator arm in the kinematic chain, i.e., on the manual flange of the manipulator arm. A guidance force can be introduced into the mechanical structure of the manipulator arm by means of said handle or said section of the handle. However, a guidance force can also be introduced into the mechanical structure of the manipulator arm by directly touching, in particular, by grasping the last link of the manipulator arm in the kinematic chain. Such a guidance force, which is applied to the manipulator arm by the operator of the industrial robot, can be directly measured, for example, by means of sensors, for example, force sensors that are designed and configured specifically for this purpose, or can be indirectly calculated from the measured values at the already existing joint sensors, in particular, force/torque sensors of the manipulator arm, or can be indirectly determined from the motor currents of the drives of the joints of the industrial robot. As an alternative, an additional embodiment provides that the manual adjustment of the manipulator arm is not performed through manual guidance, but rather by moving via an operator control device, in particular, by means of keys or a joystick.

For example, a lightweight robot with seven axes has a kinematically redundant structure, which covers the six possible directions of motion in space by means of the seven degrees of freedom of the robot. As a result, it is generally possible to move the pose of a tool reference point, for example, a TCP of an end effector into an infinite number of robot positions. A very popular method for resolving this redundancy is the definition of a redundancy circle that is described by various positions of, for example, the elbow joint. In this case an ideal position of the elbow joint during the movement is unknown, because the choice of said ideal position has to be different from application to application. To this end there are a number of approaches that prioritize, for example, good controllability, a large range of motion in terms of singularities and the angular constraints of the joint or a low load on the drives.

In addition to the high mobility, a major advantage of a lightweight robot is its integrated force sensor that makes it very easy to hand teach the robot, i.e., to hand guide the robot for the programming. At the same time the redundancy makes it possible not only to manually guide the pose of the tool reference point, but also to manually define the position of the elbow. In particular, a combination of the joint angles, i.e., the pose (position and orientation) of a link-fixed coordinate system in space or more specifically in the plane, may be construed as the position of the elbow.

Then during the automatic execution of the robot program, the robot moves to the programmed pose, i.e., the taught pose, even in the stored position.

This procedure is very user friendly and generates easily predictable motions of the robot. However, the user defines not only the pose of the tool reference point by specifying in concrete terms the position, but also in each instance the performance of the robot. This performance, expressed by means of the so-called kinetostatic properties, i.e., for example, the transmission of the force and speed from the Cartesian space into the axial space and vice versa, the accuracy and the stiffness that the robot achieves in a defined TCP pose, is distributed not only very non-homogeneously in the working space of the robot, but also varies over the redundancy parameter of the elbow position, which is used here as an example. The properties of the robot in a certain pose and position can be predicted only with much difficulty and in-depth expert knowledge. As a result, an unskilled user can easily program the robot, but can also unintentionally and quickly give the robot poorer properties. For many applications these properties will still be sufficient and in the tolerable range. If, however, the aim is to operate the robot at the limits of its maximum capacity, for example, with respect to the cycle time, dynamics, payload or accuracy, then the user's random setting of the robot's position will no longer lead to the desired goal.

If, in contrast, only the poses of the tool reference point are taught without the entire pose of the manipulator arm, then an optimization strategy could be used to select the positions of the robot in accordance with criteria of the most diverse kind during the automatic execution of the program. Then, however, said positions of the robot will differ, as a general principle, from the positions during the teaching process. The consequences of the motion that cannot be predicted in advance may be collisions that present a hazard to both the human being and the machine.

In order to program at this point the sequences of motion, which can run fully automatically in an automatic mode, it is known to adjust in a hand-guided manner the manipulator arm of the redundant industrial robot until the tool reference point is in a desired position and optionally also in a desired orientation. The tool reference point can also be referred to as the tool center point (TCP) and can be, for example, a working point of a tool that is mounted on the last link of the manipulator arm, the manual flange. As an alternative, the tool reference point or more specifically the tool center point (TCP) may also be, for example, a fixed point on the manual flange of the manipulator arm. In such a desired pose of the tool reference point in space, the coordinates of this point in space that are represented, for example, by three position values (X, Y, Z) and three orientation values (A, B, C) are saved as the position values in a robot program of the robot control unit. As a result, the sequences of motion can be programmed by means of a succession of numerous stored poses of the tool reference point. Then it is possible to move in succession to the stored poses of the tool reference point, for example, in a point to point motion mode (PTP) by means of the robot control unit. As an alternative, however, it is also possible to determine, i.e., to calculate in the robot control unit, a path of motion for the tool reference point, for example, in the form of linear paths (LIN), which run from one stored pose of the tool reference point to the next, or in the form of spline curves (SPLINE), which extend over a plurality of stored poses of the tool reference point.

When calculating the paths of motion from such supporting points of poses of the tool reference point in space, the pose of the manipulator arm, i.e., all of the joint positions considered as a whole, is automatically calculated in the case of redundant industrial robots. In so doing, it is necessary to resolve the so-called redundancy. This means that a clear and unambiguous joint position value also has to be assigned to the redundant joint(s), for which an infinite number of joint position values would be possible, if the joint position values are recalculated from the respective pose of the tool reference point. Up until now, this resolution of the redundancy did not take place until the instant that the robot program had already been totally created and executed in the automatic mode. The net result is that the composite pose of the manipulator arm during the sequence of motion is different from that at the time of the programming at the instant that the individual poses of the tool reference point were recorded. This means that the manipulator arm can exhibit a totally different behavior in space than the behavior that had been set by the operator, i.e., the programming, during the manually guided adjustment. As a result, the situation may arise after the programming that during the automatic mode the manipulator arm may exhibit undesired or even dangerous behavior that may extend even as far as to collisions.

In order to remedy the aforementioned drawback, an alternative programming procedure provides that the poses of the tool reference point are not saved or not only the poses of the tool reference point are saved in the programming phase, but that, in addition or as an alternative to the poses of the tool reference point, all of the joint position values of all of the joints of the manipulator arm are acquired and saved. In such a case there is no need to resolve the redundancy, because all of the joint position values have already been determined in advance through the teaching process, the so-called “teaching.” In this manner of programming, however, the operator, i.e. programming, has to set not only the tool reference point, but also all of the joints by hand. At a minimum, however, said operator has to set by hand the one redundant joint. This means, on the one hand, a greater programming complexity and, on the other hand, there is the risk that the operator will select poses for the manipulator arm that on the whole are poor and that could be disadvantageous in terms of the sequences of operations that the industrial robot is supposed to carry out automatically later on.

Since the invention provides that as early as during a hand-guided adjustment of the manipulator arm the joint position values of all of the joints of the manipulator arm are recalculated from the second position and the second orientation of the tool reference point of the manipulator arm while simultaneously resolving the redundancy by determining an optimized joint position value of the at least one redundant joint, and since all of the joints of the manipulator arm, actuated by the robot control unit, are automatically set on the basis on the recalculated, optimized joint position values during the manually guided adjustment, the operator can concentrate on the programming of the poses and the paths of motion of the tool reference point without having to take into consideration the pose of the entire manipulator arm. In particular, said operator himself does not have to perform the manual adjustment. An additional advantage is that the operator obtains directly by way of the immediate recalculation, which occurs automatically in the background, and by way of the setting of all of the joints of the manipulator arm, feedback about the subsequent actual pose of the entire manipulator arm as early as during the manually guided programming. Such an arrangement has the additional advantage that it is possible to program the sequences of motion in a simple and fast way and to obtain, in particular, a reliably executable and predictable robot program.

In a further refinement of the method according to the invention, an algorithm is selected from a plurality of various specified algorithms for recalculating the joint position values of all of the joints of the manipulator arm from the second position and second orientation of the tool reference point of the manipulator arm while simultaneously resolving the redundancy by determining the optimized joint position value of the at least one redundant joint.

In order to find a single suitable joint position from a plurality or more specifically from an infinite number of solutions for the joint position of the at least one redundant joint, algorithms of the most diverse kind, in particular, optimization algorithms are known. At this point the present embodiment provides that at least two algorithms, in particular, a plurality of different algorithms for resolving the redundancy are available in the robot control unit and that one algorithm is selected by the operator, in particular, prior to carrying out the method, which forms the basis of the present invention, if desired, even while carrying out the method, which forms the basis of the present invention.

Based on the aforesaid, the selection of the algorithm by an operator of the industrial robot can occur, in particular, prior to said operator's manually guided adjustment of the manipulator arm. Since the operator selects one algorithm from a plurality of possible algorithms prior to the hand-guided programming of the sequences of motion, the operator can specify, according to certain criteria, the behavior of the redundant joints, in particular, the entire pose of the manipulator arm during the hand-guided programming and, in so doing, simultaneously adapt a basic behavior of the manipulator arm to a processing task and/or a handling task that is to be programmed. This feature improves once more the predictability of the behavior of the manipulator arm both during and also after the hand-guided programming.

In a particular embodiment the algorithms, which allow an automatic optimization of the joint position values of the at least one redundant joint in accordance with various static and/or kinetic properties of the manipulator arm, can be stored in the robot control unit. The operator can select a desired algorithm, in particular, prior to the hand-guided programming of the robot program; and then this selected desired algorithm is used during the hand-guided adjustment of the manipulator arm. That is, the joints and, in particular, the redundant joints of the manipulator arm are then automatically adjusted accordingly.

As an alternative or in addition, it is possible for the optimization of the joint position value of the at least one redundant joint according to the static and/or kinetic properties of the manipulator arm to be carried out as a function of the requirement of the sequences of motion that are to be programmed. This may mean that each algorithm, which is stored in the robot control unit, is allocated a requirement that is compatible with the optimization strategy. In this way the programming of the industrial robot can be simplified for an operator, since he does not have to have any special knowledge of the respective characteristic of the individual algorithms, but rather the operator merely selects a requirement that fits his task; and a particular algorithm in turn is allocated to this selected suitable requirement in the robot control unit.

The property that is to be optimized may be, for example, a process force, a stiffness of the manipulator arm, a positioning accuracy of the manipulator arm, a motion speed of the manipulator arm, an acceleration capability of the manipulator arm, and/or a sensitivity when there is force feedback from the manipulator arm. Thus, for example, it is advantageous, if in the case of a task involving the metal cutting machining of a workpiece by means of a robot guided tool, such as drilling or milling, the entire manipulator arm exhibits a very high stiffness, so that dimensionally accurate machining is guaranteed; and the high process forces, generated during the metal cutting machining operation, can be totally absorbed by the mechanical structure of the manipulator arm. In another application, such as, for example, grinding or polishing, it may be necessary for the manipulator arm to exhibit a certain compliance, so that the robot guided tool can apply only a reduced amount of maximum force on the workpiece. In the first case it is expedient to allocate to the redundant joints a joint position that exhibits a high static stiffness of the manipulator arm, for example, with respect to the direction of the process force. In the second case it is expedient to allocate to the redundant joints a joint position that exhibits a high elasticity of the manipulator arm, for example, with respect to the direction of the process force.

As a result, such an arrangement allows the optimization of the joint position value of the at least one redundant joint to be carried out additionally as a function of one or more specified directions of action. Depending on the direction of action, for example, a direction of the process force, a larger moment or a smaller moment can be impressed selectively on the respective joint under consideration, as a function of the joint positions of the manipulator arm, in particular, the redundant joints of the manipulator arm.

The one or more directions of action to be specified can also be manually specified to the robot control unit by an operator of the industrial robot prior to said operator's manually guided adjustment of the manipulator arm; or said one or more directions of action to be specified can be automatically determined by the robot control unit and, in particular, can be automatically determined by the robot control unit from the direction of motion specified by the operator by his manual guidance of the manipulator arm.

In a further refinement of the method according to the invention, the robot control unit can be designed and/or configured to allow a manual adjustment of the joints of the manipulator arm, in particular, at least one redundant joint after an automatic setting or during an automatic setting of all of the joints of the manipulator arm, actuated by the robot control unit, on the basis of the recalculated, optimized joint position values during the manually guided adjustment.

With the basic method the operator sees directly and from the start, in particular, during the hand-guided programming, the subsequent composite pose of the manipulator arm during the program run. Said operator can check by eye this composite pose of the manipulator arm during the hand-guided programming; and in the said further refinement of the invention, said operator can still carry out, as desired, a manual adjustment of the joints of the manipulator arm, in particular, the at least one redundant joint after an automatic setting or during an automatic setting, in order, for example, to be able to correct in a targeted way the automatically optimized composite pose of the manipulator arm. This arrangement makes it possible to ensure with extreme operating simplicity the maximum possible performance of the robot together with the maximum possible predictability of the motion.

In this case the robot control unit can be designed and/or configured to allow a manual adjustment of the joints of the manipulator arm with force feedback. The force feedback can increase linearly or progressively with the deviation from the optimized joint position values, in particular, of the at least one redundant joint.

The engineering object of the invention is achieved not only by means of the inventive method as such, but also by means of an industrial robot comprising a robot control unit, which is designed and/or configured to execute a robot program comprising programmed sequences of motion, and comprising a redundant manipulator arm with a plurality of successive links and joints, which are automated according to the robot program and/or can be automatically adjusted in a manual operation, wherein the robot control unit is designed and/or configured to carry out, as described, a method.

In summary, the method according to the invention provides that when the tool reference point is programmed by hand, the whole manipulator arm directly assumes a composite pose that the manipulator arm will subsequently exhibit during the automatic execution of the robot program. In this case the composite pose of the manipulator arm can be selected in such a way that it is kinetostatically optimal with respect to the subsequent task.

In this respect the operator can position and orient, for example, the end effector of the manipulator arm by intuitively moving said end effector by hand in accordance with the processing and/or handling task that is to be programmed. At the same time the operator can also specify whether the robot is to satisfy any special requirements in the desired poses. These additionally programmed properties, in particular, the kinetostatic properties of the robot, are added to a pose or to a motion section in the robot control unit. From this information, planning algorithms can calculate the instantaneous optimal pose of the manipulator arm. The optimized position is transmitted directly to the drives of the joints of the manipulator arm, so that the operator can see directly the correct poses of the manipulator arm and can continue to work with said poses.

Based on the aforesaid, the programming can be performed as follows. First, the operator selects a tool reference point, with which he would like to work. That is, he would like to move the link of the manipulator arm, associated with said tool reference point, by hand. For example, in a gravitation compensation mode of the robot the operator can move the tool reference point by hand into a desired pose. In this case the position of the elbow joint, for example, is irrelevant. At this point a desired property, such as, for example, an expected direction of the maximum amount of force and/or moment to be generated, an expected direction of the maximum speed to be generated, an expected direction of the maximum dynamics/acceleration to be generated, a desired direction of the maximum accuracy, a desired direction of the maximum force sensitivity, a best control characteristic and/or a desired direction of the maximum mechanical stiffness, can also be stored for the desired pose.

These properties may be crucial, for example, when the robot is supposed to perform machining operations, such as drilling, grinding, milling or precision, sensitive joining or measuring tasks, or in the case of handling tasks when said robot reaches the limits of its load capacity or cycle time.

In this case the programming of the direction can be performed, for example, with ease by simply guiding the tool by hand. In so doing, a salient tool direction, such as, for example, the direction of thrust, could be used; or an explicit coordinate direction could be selected. Moreover, it is just as possible to relate the desired kinetostatic properties to a plane. That is, the robot is supposed to exhibit, for example, the maximum accuracy, which is possible in this pose, in a desired plane. This feature can also be defined by means of the orientation of the tool, which in this case defines the normal vector of the plane. In this case the direction can be specified independently of the actual target pose. After the direction of the property has been defined, the manipulator arm can resume its programmed pose and, in so doing, automatically selects the optimal position.

Some examples of concrete embodiments of an industrial robot, which can be operated according to the method of the present invention, are explained in more detail in the following description with reference to the accompanying figures. Concrete features of these embodiments, which are presented as examples, may represent either individually or in any combination the general features of the invention, irrespective of the concrete correlation, in which they are mentioned,

The drawings show in:

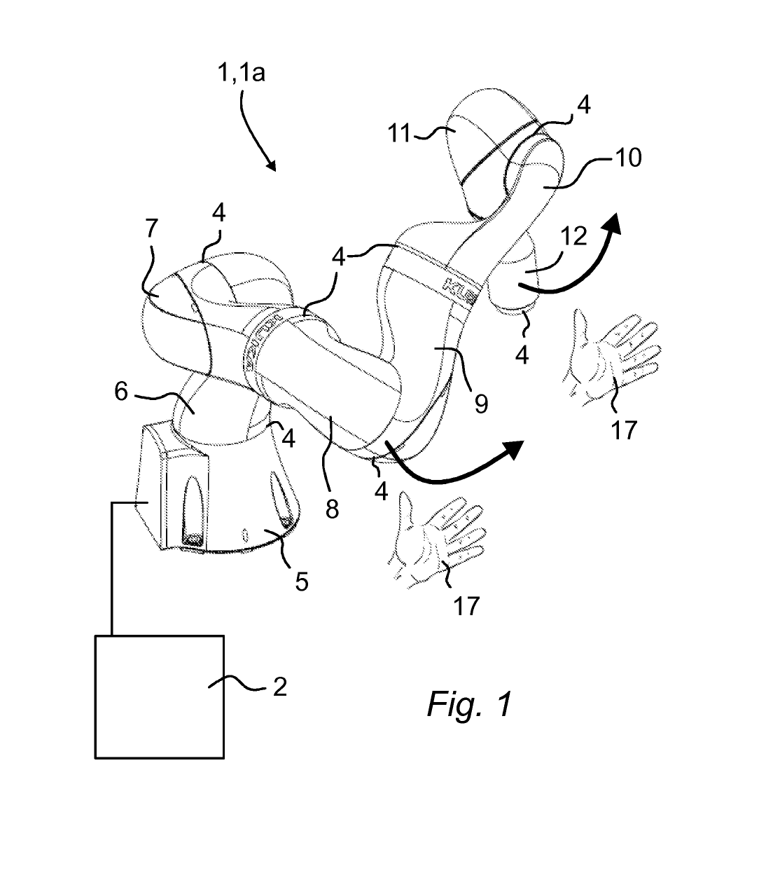

FIG. 1 a perspective view of a redundant industrial robot, which is constructed as a lightweight robot comprising a robot control unit, which is shown in schematic form, and a manipulator arm in a pose that can be adjusted by guiding said manipulator arm by hand;

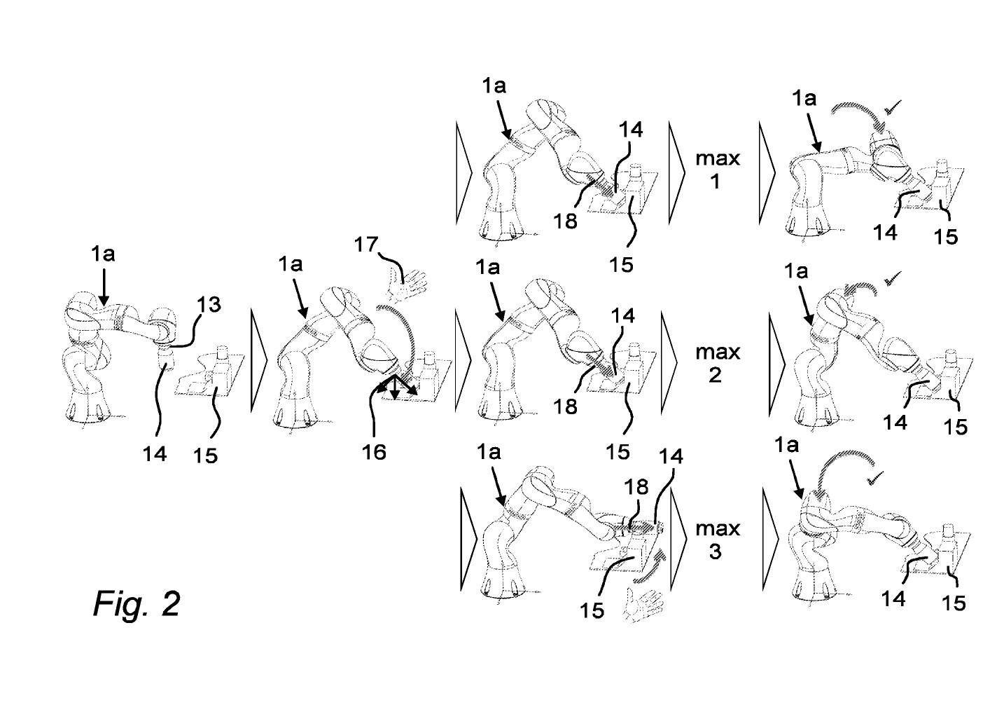

FIG. 2 a number of variants of the redundancies, resolved in different ways, as a function of the various properties of the manipulator arm that are to be optimized;

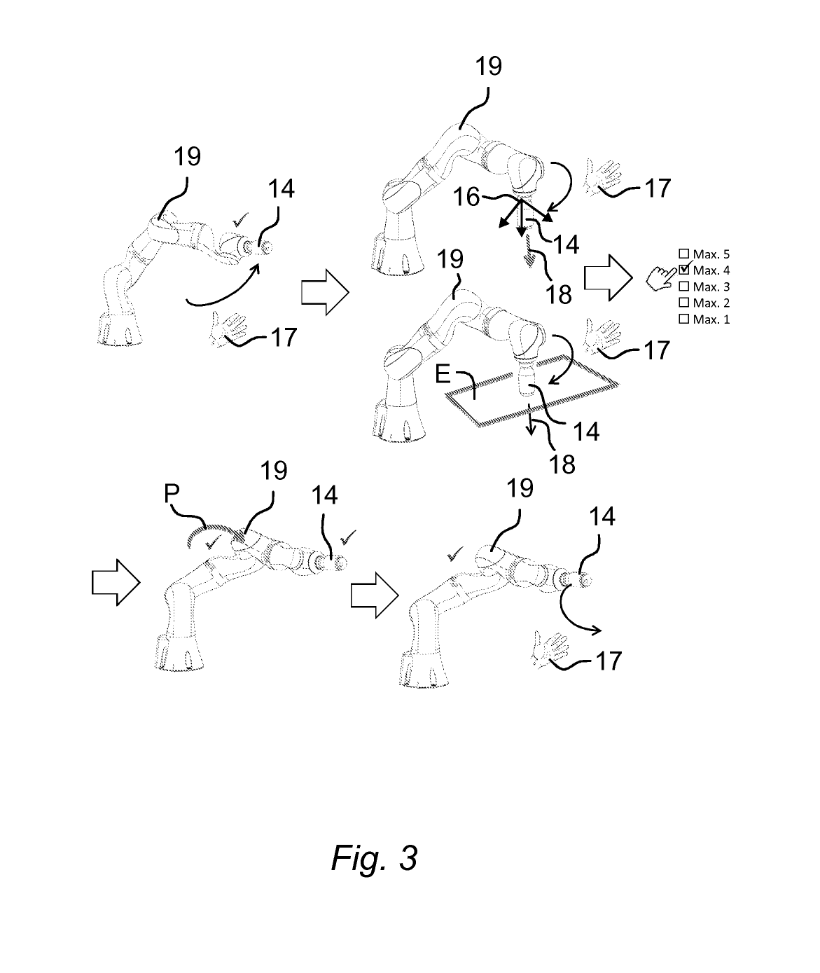

FIG. 3 a graphical rendering of a procedure, shown as an example of an inventive method for programming the sequences of motion at the redundant lightweight robot from FIG. 1;

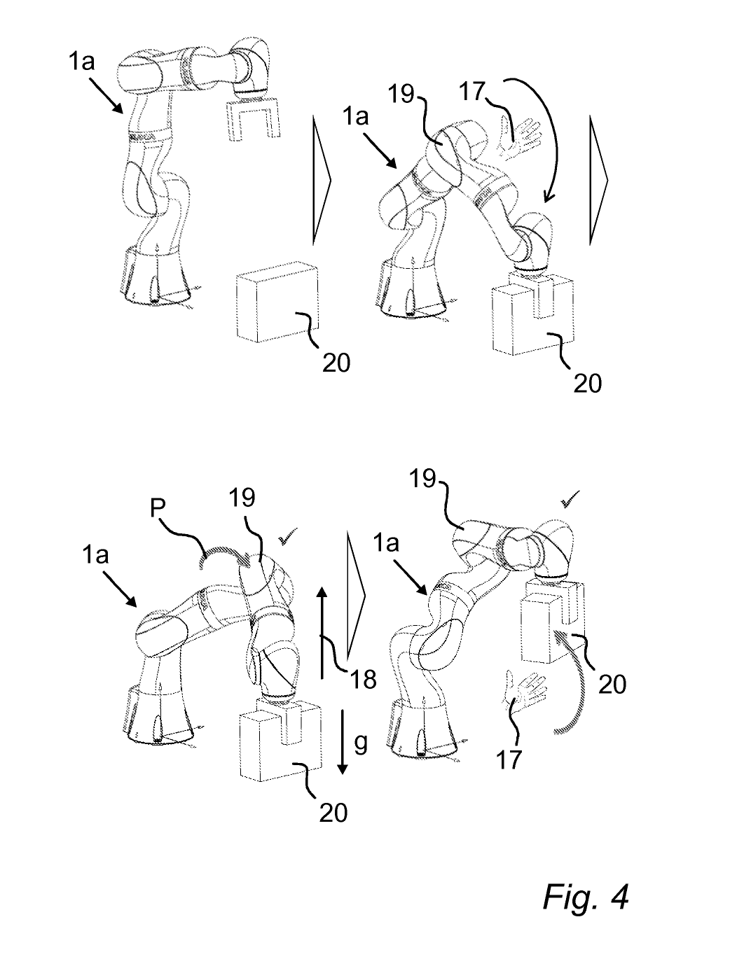

FIG. 4 a graphical rendering of the procedure of an inventive method for programming the sequences of motion at the redundant lightweight robot from FIG. 1, using the example of a grasp and lift task; and

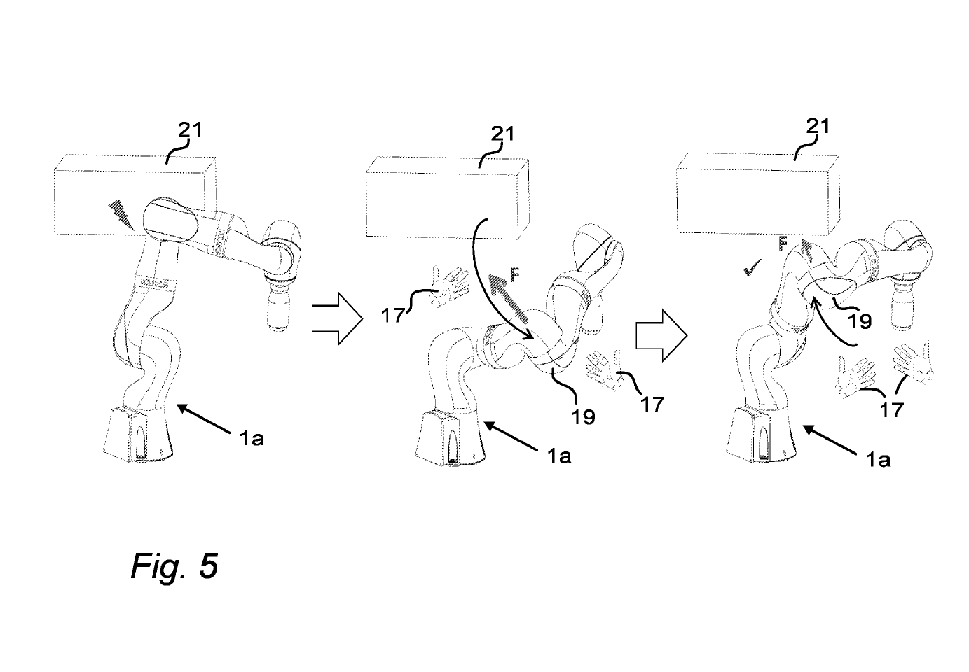

FIG. 5 a graphical rendering of the procedure of an inventive method, which allows an optimized pose of the manipulator arm to be corrected by hand, using the example of avoiding collisions.

FIG. 1 shows, as an example, a robotic workstation comprising a manipulator arm 1a of an industrial robot 1. In this embodiment, which is shown as an example, the industrial robot 1 is constructed as a so-called lightweight robot of the model KUKA LBR, which comprises the manipulator arm 1a and an associated robot control unit 2. In the case of the present embodiment, which is shown as an example, the redundant manipulator arm 1a comprises eight links 5 to 12, which are arranged in series and are rotatably connected to each other by means of seven joints 4.

The robot control unit 2 of the industrial robot 1 is designed or rather configured to execute a robot program, by means of which the joints 4 of the manipulator arm 1a are automated in accordance with its robot program or can be automatically adjusted or more specifically pivotally moved in a manual operation. For this purpose the robot control unit 2 is connected to actuable electric drives that are designed to adjust the joints 4 of the manipulator arm 1a.

The robot control unit 2 is designed and/or configured to carry out one or more of the inventive methods for programming the sequences of motion of the redundant industrial robot 1 by means of a manually guided adjustment of the pose of a manipulator arm 1a, as described in more detail below by means of a plurality of concrete embodiments that are shown only for illustrative purposes.

FIG. 2 shows some examples of the steps of the method according to the invention. The extreme left drawing shows the manipulator arm 1a with a tool 14 that is mounted on the manual flange 13 of the manipulator arm. In this case of the present example, the tool is a grinding tool. The tool 14 is designed for machining a workpiece 15. In this context a tool reference point 16 may be, for example, a point on the axis of rotation of the tool 14.

In a first step of the process, which is shown in the center left drawing in FIG. 2, the link 5 to 12 of the manipulator arm 1a that is associated with the tool reference point 16 is adjusted by hand from a first position and first orientation in space into a second position and/or second orientation in space. In this case the manually guided adjustment can be performed, as shown, by a hand 17 of an operator of the industrial robot 1. In the embodiment that is shown for illustrative purposes, the manually guided link 5 to 12 is the manual flange 13 of the manipulator arm 1a.

An optimization of the joint position values of the at least one redundant joint 4 can be carried out as a function of one or more specified directions of action, which is depicted in the center right three drawings in FIG. 2. Depending on the direction of action 18, for example, a process force direction, a larger moment or a smaller moment can be impressed by choice on the respective joint 4 under consideration, as a function of the joint positions of the manipulator arm 1a, in particular, the redundant joints 4 of the manipulator arm 1a.

One or more directions of action 18 that are to be specified can be manually specified to the robot control unit 2 by an operator of the industrial robot 1 prior to said operator's manually guided adjustment of the manipulator arm 1a or can be automatically determined by the robot control unit 2, in particular, can be automatically determined by the robot control unit 2 from the direction of motion specified by the operator by his manual guidance of the manipulator arm 1a.

The property to be optimized may be, for example, a process force, a stiffness (MAX 1) of the manipulator arm, a positioning accuracy of the manipulator arm, a motion speed of the manipulator arm, an acceleration capacity of the manipulator arm and/or a sensitivity (MAX 2) when there is force feedback from the manipulator arm 1a. For example, it is advantageous if in the event of a task involving a metal cutting machining operation of the workpiece 15 by means of the robot guided tool 14, such as drilling or milling, the entire manipulator arm 1a exhibits a very high stiffness (MAX 1), so that a dimensionally accurate machining operation is ensured; and the high process forces, generated by the metal cutting machining operation, can be completely absorbed by the mechanical structure of the manipulator arm 1a. In another application, such as, for example, a grinding or polishing operation, it may be necessary for the manipulator arm 1a to show a certain compliance and, as a result, better sensitivity, so that the robot guided tool 14 can apply only a reduced maximum force on the workpiece 15. In the first case it is expedient to assign to the redundant joints 4 a joint position that exhibits a high static stiffness of the manipulator arm 1a, for example, with respect to the direction of the process force, a feature that is shown in the top and bottom drawings in FIG. 2. In the second case it is expedient to assign to the redundant joints 4 a joint position that exhibits a high sensitivity (MAX 2) of the manipulator arm, for example, with respect to the direction of the process force, a feature that is shown in the center drawings in FIG. 2.

As shown in the three drawings on the extreme right side in FIG. 2, the joint position values of all of the joints 4 of the manipulator arm 1a are recalculated in different ways from the second position and the second orientation of the tool reference point 16 of the manipulator arm 1a while simultaneously resolving the redundancy in different ways by determining an optimized joint position value of the at least one redundant joint 4 and an automatic setting of all of the joints 4 of the manipulator arm 1a, actuated by the robot control unit 2, on the basis of the recalculated, optimized joint position values during the manually guided adjustment. Thus, in the variant, which is shown in schematic form at the bottom in FIG. 2, an optimization of the joint position values is chosen with respect to a high stiffness (MAX 1) and a direction of action 18, which is selected in the bottom drawings, for example, in such a way that it points from left to right in a horizontal direction. This means that the joint position values are to be optimized in such a way that the manipulator arm 1a should exhibit a high stiffness in a horizontal direction, so that, for example, in the course of machining the workpiece 15, as shown in the drawing at the bottom on the extreme right hand side in FIG. 2, the tool 14 can generate a high process force without causing the manipulator arm 1a to deflect.

The drawings of three variants, which are shown in schematic form, as an example, one below the other in FIG. 2, illustrate how an algorithm is selected from a plurality of various specified algorithms for recalculating the joint position values of all of the joints 4 of the manipulator arm 1a from the second position and second orientation of the tool reference point 16 of the manipulator arm 1a while simultaneously resolving the redundancy by determining the optimized joint position value of the at least one redundant joint 4.

The selection of the algorithm can be performed, as shown on the extreme right in FIG. 3, by the hand 17 of an operator of the industrial robot 1, in particular, prior to said operator's manually guided adjustment of the manipulator arm 1a, as shown at the top left in the drawing. In the case of the embodiment shown as an example in FIG. 3, the operator selects, for example, a maximum accuracy (MAX 4) and defines a desired direction of action 18.

A programming procedure may run as follows. First, the operator selects a tool reference point 16, with which he would like to work. That is, he would like to move the link 4, for example, the manual flange 13 of the manipulator arm 1a, which is associated with said tool reference point, by hand. For example, in a gravitation compensation mode of the industrial robot 1 the operator can move the tool reference point 16 by hand into a desired pose, which is shown in the top left drawing in FIG. 3. In this case the position of an elbow joint 19, for example, is irrelevant. At this point a desired property (MAX 1 to MAX 5), such as, for example, an expected direction of the maximum amount of force (MAX 5) and/or moment to be generated, an expected direction of the maximum speed (MAX 3) to be generated, an expected direction of the maximum dynamics/acceleration to be generated, a desired direction of the maximum accuracy (MAX 4), a desired direction of the maximum force sensitivity (MAX 2), a best control characteristic and/or a desired direction of the maximum mechanical stiffness (MAX 1), can also be stored for the desired pose.

In this respect the programming of the direction can be performed, as shown in the top right drawing in FIG. 3, with ease by means of a guidance with the hand 17 of the operator at the tool 14. In this case a salient tool direction, such as, for example, the direction of thrust (arrow), could be used; or an explicit coordinate direction could be selected. It is just as possible to relate the desired kinetostatic properties to a plane E. That is, the industrial robot 1 is supposed to exhibit, for example, the maximum accuracy (MAX 4), which is possible in this pose, in a desired plane E. This feature can also be defined by means of the orientation of the tool 14, which in this case defines the normal vector (arrow) of the plane E. At the same time the direction can be specified independently of the actual target pose. After the direction of the property has been defined, the manipulator arm 1a can resume its programmed pose, which is shown in the bottom right drawing in FIG. 3; and, in so doing, compared to the original pose of the manipulator arm 1a, as shown in the top left drawing, the elbow joint 19 is automatically optimized in the optimal position, as indicated by the swivel of the arrow P in the bottom left drawing in FIG. 3. Thereafter, the manipulator arm can be moved further by hand in an unrestrained manner and still retain its properties.

FIG. 4 shows by means of a programming task, which is presented only for illustrative purposes, the lifting and moving of an object 20 by means of the manipulator arm 1a in four steps. In the case of the task, which is used for illustrative purposes, it is not necessary for the operator of the industrial robot to specify the directions of action 18. The requisite direction of action 18, i.e., the direction of action 18 that is oriented in the opposite direction of the force of gravity, is defined specifically in terms of the task solely by means of the task of lifting that was previously defined or more specifically selected in a menu. In this respect the direction of action 18 can be automatically determined by means of the robot control unit 2. After the gripping operation, which is shown in the top right drawing in FIG. 4, is programmed by a manually guided adjustment by means of the hand 17 of the operator, an automatic optimization of the joint position values can be performed, in particular, for the redundant elbow joint 19, as shown by the arrow P in the bottom left drawing in FIG. 4, so that the object can be lifted, as shown in the bottom right drawing in FIG. 4, in an optimized pose of the manipulator arm 1a.

FIG. 5 shows, as an example, an embodiment, in which after an automatic setting or also during an automatic setting of all of the joints 4 of the manipulator arm 1a to the optimized joint position values, a manual adjustment of the joints 4 of the manipulator arm 1a is also allowed, so that, for example, in the case of an optimized pose, which would collide with an obstacle 21, as shown in the left hand drawing in FIG. 5, an additional, manual adjustment of the joints 4 of the manipulator arm 1a is possible, so that in a special case the hand 17 of the operator can swivel, for example, the elbow joint 19 away from the obstacle 21, so that then, as shown in the right hand drawing in FIG. 5, a modified programming operation occurs that does not collide with the obstacle 21, but rather moves past the obstacle 21 close to the optimized pose of the manipulator arm 1a. In this respect the robot control unit 2 can be designed and/or configured to allow a manual adjustment of the joints 4 of the manipulator arm 1a only with force feedback (arrow F). The force feedback can increase linearly or progressively with the deviation from the optimized joint position values, in particular, of the at least one redundant joint 4. This may mean that as the deviation from the pose of the manipulator arm 1a that is set by the operator in relation to the environment of the obstacle 21 increases, it becomes increasingly more difficult to move the manipulator arm 1a by hand. That is, said manipulator arm can be moved only with increasingly more force, so that an increasing deviation from the optimized pose of the manipulator arm 1a with force feedback is communicated to the operator. This may induce the operator to pivot the pose of the manipulator arm 1a only insofar, and perhaps only slightly out of the optimized pose, as this is necessary at all in order to bypass the obstacle 21.

1-12. (canceled)

13. A method for programming sequences of motion of a redundant industrial robot by manually guided adjustment of the pose of a manipulator arm of the industrial robot, the manipulator arm comprising a plurality of successive links that are connected by adjustable joints, wherein the adjustable joints include at least one redundant joint and which can be adjusted in such a way that they are actuated by at least one robot control unit of the industrial robot, the method comprising:
adjusting in a manually-guided manner the link of the manipulator arm that is associated with a tool reference point from a first position and first orientation in space to a second position and/or second orientation in space;
recalculating the joint position values of all of the joints of the manipulator arm from the second position and second orientation of the tool reference point of the manipulator arm while simultaneously resolving the redundancy by determining an optimized joint position value of the at least one redundant joint; and
automatically setting all of the joints of the manipulator arm, actuated by the robot control unit, on the basis of the recalculated, optimized joint position values during the manually guided adjustment.

14. The method of claim 13, wherein simultaneously resolving the redundancy by determining the optimized joint position value of the at least one redundant joint comprises selecting an algorithm from a plurality of specified different algorithms for recalculating the joint position values of all of the joints of the manipulator arm from the second position and second orientation of the tool reference point of the manipulator arm.

15. The method of claim 14, wherein the algorithm is selected by an operator of the industrial robot prior to manually-guided adjusting of the link of the manipulator arm.

16. The method of claim 13, wherein determining an optimized joint position value of the at least one redundant joint is based on the static and/or kinetic properties of the manipulator arm.

17. The method of claim 16, wherein determining an optimized joint position value of the at least one redundant joint based on the static and/or kinetic properties of the manipulator arm is carried out as a function of the requirement of the sequences of motion that are to be programmed.

18. The method of claim 16, wherein the property of the manipulator arm upon which optimization is based is at least one of:
a process force;
a stiffness of the manipulator arm;
a positioning accuracy of the manipulator arm;
a motion speed of the manipulator arm;
an acceleration capability of the manipulator arm; or
a sensitivity when there is force feedback from the manipulator arm.

19. The method of claim 16, wherein determining an optimized joint position value of the at least one redundant joint is carried out as a function of one or more specified directions of action.

20. The method of claim 19, wherein the one or more directions of action are either:
manually specified to the robot control unit by an operator of the industrial robot prior to manually guided adjustment of the manipulator arm; or
automatically determined by the robot control unit from the direction of motion specified by the operator by manual guidance of the manipulator arm.

21. The method of claim 13, wherein the robot control unit is designed and configured to allow a manual adjustment of the joints of the manipulator arm after an automatic setting, or during an automatic setting, of all of the joints of the manipulator arm, actuated by the robot control unit, on the basis of the recalculated, optimized joint position values during the manually guided adjustment.

22. The method of claim 13, wherein the robot control unit is designed and configured to allow a manual adjustment of the at least one redundant joint of the manipulator arm after an automatic setting, or during an automatic setting, of all of the joints of the manipulator arm, actuated by the robot control unit, on the basis of the recalculated, optimized joint position values during the manually guided adjustment.

23. The method of claim 21, wherein the robot control unit is designed and configured to allow a manual adjustment of the joints of the manipulator arm with force feedback.

24. The method of claim 23, wherein the force feedback increases linearly or progressively with the deviation from the optimized joint position values of the at least one redundant joint.

25. An industrial robot, comprising:
a robot control unit which is designed and configured to execute a robot program comprising programmed sequences of motion; and
a redundant manipulator arm (1a) with a plurality of successive links (5 to 12) and joints (4), which are automated according to the robot program and/or can be automatically adjusted in a manual operation;
wherein the robot control unit is designed and configured to:
adjust in a manually-guided manner the link of the manipulator arm that is associated with a tool reference point from a first position and first orientation in space to a second position and/or second orientation in space,
recalculate the joint position values of all of the joints of the manipulator arm from the second position and second orientation of the tool reference point of the manipulator arm while simultaneously resolving the redundancy by determining an optimized joint position value of the at least one redundant joint, and
automatically set all of the joints of the manipulator arm, actuated by the robot control unit, on the basis of the recalculated, optimized joint position values during the manually guided adjustment.
